(19) United States
(12) Patent Application Publication
(10) Pub. No.: US 2003/0173800 A1
(43) Pub. Date: Sep. 18, 2003

(54) Integrally stiffened extruded panels for ground vehicles

(76) Inventor: Timothy Langan, Catonsville, MD (US)

Correspondence Address: Alan G. Towner, Pietragallo, Bosick & Gordon, One Oxford Centre, 38th Floor, 301 Grant Street, Pittsburgh, PA, 15219, US

(21) Appl. No.: 10/341,072

(22) Filed: Jan. 13, 2003

Related U.S. Application Data
(60) Provisional application No. 60/348,848, filed on Jan. 14, 2002.

(51) Int. Cl. B62D 33/023

(52) U.S. Cl. 296/191

(57) ABSTRACT

Integrally stiffened extruded metal panels for ground vehicles are provided. The panels may be extruded in the form of a tube, then cut and un-rolled to provide the desired shape, e.g., for a sidewall or top wall of a ground vehicle such as a railway car. In a preferred embodiment, the integrally stiffened extruded panels have widths and lengths sufficient to cover substantially the entire height and length of the ground vehicle, thereby eliminating seams along the sidewalls of the vehicle.

### CROSS REFERENCE TO RELATED APPLICATION

This application claims the benefit of U.S. Provisional Patent Application Ser. No. 60/348,848 filed Jan. 14, 2002.

### FIELD OF THE INVENTION

The present invention relates to the use of integrally stiffened extruded panels in vehicles such as railway cars.

### BACKGROUND INFORMATION

Exterior panels of conventional ground vehicles, such as side panels of railway cars, have been made from several sheets that are welded together. The use of such multiple welded sheets has led to safety concerns and has resulted in increased fabrication costs and vehicle weight.

### SUMMARY OF THE INVENTION

An aspect of the present invention is to provide an integrally stiffened ground vehicle panel comprising an extruded exterior metal panel, and co-extruded interior metal stiffeners connected to the panel.

Another aspect of the present invention is to provide a method of making an integrally stiffened ground vehicle panel comprising co-extruding an exterior metal panel and interior metal stiffeners.

A further aspect of the present invention is to provide an integrally stiffened ground vehicle panel assembly comprising a first panel including an extruded exterior metal panel with co-extruded interior metal stiffeners, and a second panel connected to an edge of the first panel.

These and other aspects of the present invention will be more apparent from the following description.

### BRIEF DESCRIPTION OF THE DRAWINGS

FIG. 1 is a cross sectional view of a portion of a railway car having integrally stiffened extruded aluminum side panels and an integrally stiffened extruded aluminum top panel in accordance with an embodiment of the invention.

FIG. 2 is a cross sectional view of an aluminum extrusion including stiffeners on the outside of the tubular extrusion.

FIG. 3 is a cross sectional view of a portion of an integrally stiffened extruded aluminum panel after the panel has been cut and un-rolled from the tubular shape shown in FIG. 2.

### DETAILED DESCRIPTION

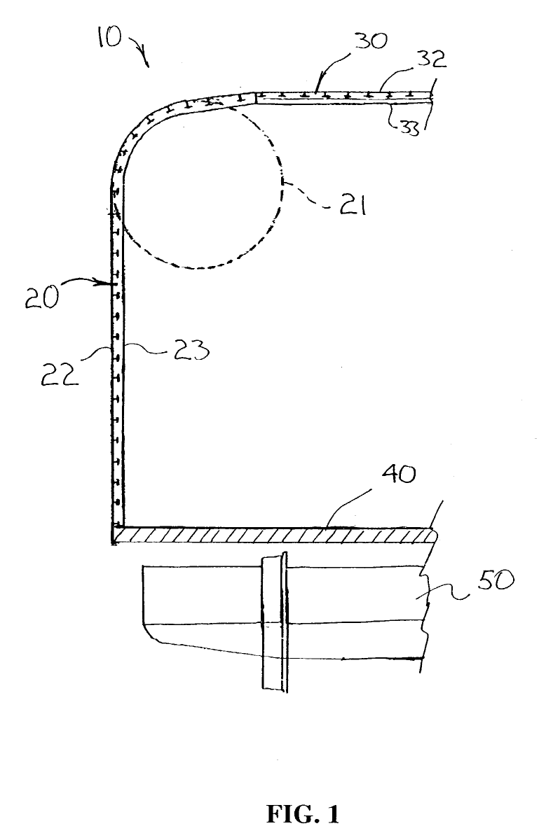

FIG. 1 is a cross sectional view of a portion of a railway car 10 which includes a sidewall 20 comprising an integrally stiffened extruded side panel 22 and a top or roof 30 comprising an integrally stiffened extruded top panel 32 in accordance with an embodiment of the present invention. Although not shown in FIG. 1, the railway car 10 includes another integrally stiffened extruded side panel attached to the top panel on the opposite side of the car. The sidewall 20 also includes an interior sidewall 23 made of metal, plastic, composite, or the like. The volume between the integrally stiffened extruded side panel 22 and the interior sidewall 23 may preferably be filled with conventional thermal insulation and/or sound insulation materials.

The side panel 22 may be attached to the top panel 32 by any suitable means such as mechanical fasteners or welding. For example, the edges of the side panel 22 and top panel 32 may be joined by friction stir welding. As shown in FIG. 1, the weld areas may be located on the roof of the railway car 10 such that the side panel 22 wraps around the upper corners of the car 10.

The integrally stiffened extruded side panel 22 and top panel 32 may be made of any suitable material, preferably an aluminum alloy. For example, the alloy may comprise a conventional aluminum alloy with scandium alloying additions. The floor 40 of the railway car 10, as shown in FIG. 1, may have any desired structure and may be made from any suitable material, such as an extruded aluminum-scandium alloy. Lithium may optionally be added to such Al—Sc alloys. Some suitable aluminum alloys include 7X5X, 7X1X and 7X0X alloys, e.g., alloy 7055. The railway car 10 may be mounted on a conventional undercarriage 50.

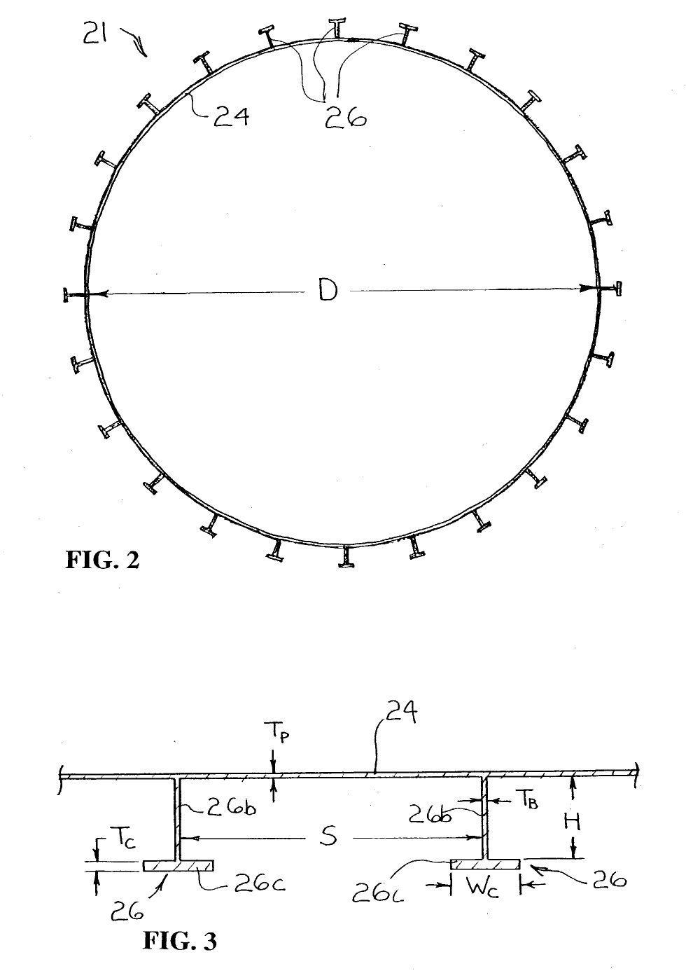

FIG. 2 is a cross sectional view of an integrally stiffened extruded pipe 21. The extruded pipe 21 is also shown in phantom in FIG. 1. In the embodiment shown in FIG. 2, the extruded pipe 21 includes a panel 24 and integrally formed stiffeners 26 extending from the surface of the panel 24. Although several T-shaped stiffeners 26 are shown in FIG. 2, any other suitable number or shape may be used for the stiffeners. The extruded pipe 21 may have any suitable diameter, e.g., from less than 1 foot to greater than 5 feet, and may have any suitable length, e.g., from less than 1 foot to 50 or 100 feet, or more.

As shown in FIG. 3, the extruded pipe of FIG. 2 may be cut by conventional metal cutting techniques and un-rolled to provide the desired shape for the vehicle panels. The portion of the panel shown in FIG. 3 is substantially flat. However, any other suitable panel shape may be provided. For example, the extruded pipe 21, or a portion thereof, may be formed into a side panel shape 22 as shown in FIG. 1. Furthermore, the extruded pipe, or portion thereof, may be formed into a top panel 32 as shown in FIG. 1.

As shown in FIG. 3, the extruded exterior panel 24 may have a typical thickness T_{P} of from about 0.03 to about 0.3 inch. The integral stiffeners may have thicknesses of from about 0.03 to about 0.3 inch. For example, the integral stiffeners 26 shown in FIG. 3 are generally T-shaped, with a base portion 26b and a cross member 26c. The base portion 26b may have a typical thickness T_{B} of from about 0.03 to about 0.3 inch, and a height H of from about 0.5 to about 2 inches. The cross member 26c may have a typical thickness T_{C} of from about 0.05 to about 0.3 inch, and a typical width W_{C} of from about 0.5 to about 2 inches. The spacing S of the stiffeners 26 along the panel 24 may typically range from about 1 to about 10 inches. In a particular embodiment, T_{P} may be about 0.076 inch, T_{B} may be about 0.072 inch, T_{C} may be about 0.153 inch, W_{C} may be about 1.067 inch, H may be about 1.27 inches, and S may be about 4.64 inches.

The side panel 22 and top panel 32, e.g., as shown in FIG. 1, may have similar or different configurations. Thus, the size, shape and/or spacing of the integral stiffeners 26 may be the same or different for the side and top panels. Furthermore, the thickness and/or gauge of the side and top panels may be the same or different. Also, the extruded pipe 21 used for the side panel may be the same or different from the extruded pipe used for the top panel. For example, if the side panel 22 has a greater width than the top panel 32, the extruded pipe 21 from which the side panel 22 is formed may have a greater diameter D than the extruded pipe 21 from which the top panel 32 is formed. Alternatively, the extruded pipes 21 may have the same diameter D, but the pipe used to form the top panel 32 may be cut or otherwise divided into two or more panels, each of which is used to form a single top panel 32.

The extruded pipe 21 may have any desired length. For example, the length may be selected in order to minimize the number of panels required to cover the length of the ground vehicle 10. For instance, an entire side and/or top panel of a rail car as shown in FIG. 1 may be made from a single extrusion. In this case, the side and/or top panel may have a length approximating the length of the rail car or other ground vehicle.

Whereas particular embodiments of this invention have been described above for purposes of illustration, it will be evident to those skilled in the art that numerous variations of the details of the present invention may be made without departing from the invention.

What is claimed is:

1. An integrally stiffened ground vehicle panel comprising:
an extruded exterior metal panel; and
co-extruded interior metal stiffeners connected to the panel.

2. The integrally stiffened ground vehicle panel of claim 1, wherein the panel and stiffeners have lengths approximating a length of the ground vehicle.

3. The integrally stiffened ground vehicle panel of claim 1, wherein the panel comprises an exterior side panel of the ground vehicle.

4. The integrally stiffened ground vehicle panel of claim 1, wherein the panel comprises an exterior top panel of the ground vehicle.

5. The integrally stiffened ground vehicle panel of claim 1, wherein the panel has a thickness of from about 0.03 to about 0.3 inch.

6. The integrally stiffened ground vehicle panel of claim 1, wherein the stiffeners extend from the panel a height of from about 0.5 to about 2 inches.

7. The integrally stiffened ground vehicle panel of claim 1, wherein the stiffeners have a thickness of from about 0.03 to about 0.3 inch.

8. The integrally stiffened ground vehicle panel of claim 1, wherein the stiffeners are substantially T-shaped with a base portion of the stiffener attached to the panel and a cross member attached to the base portion.

9. The integrally stiffened ground vehicle panel of claim 8, wherein the base portion has a thickness of from about 0.03 to about 0.3 inch and a height of from about 0.5 to about 2 inches, and the cross member has a thickness of from about 0.05 to about 0.3 inch and a width of from about 0.5 to about 2 inches.

10. The integrally stiffened ground vehicle panel of claim 1, wherein the stiffeners are spaced from each other on the panel a distance of from about 1 to about 10 inches.

11. The integrally stiffened ground vehicle panel of claim 1, wherein the panel and stiffeners comprise an aluminum alloy.

12. The integrally stiffened ground vehicle panel of claim 11, wherein the aluminum alloy comprises scandium.

13. A method of making an integrally stiffened ground vehicle panel comprising co-extruding an exterior metal panel and interior metal stiffeners.

14. The method of claim 13, wherein the panel is extruded in the form of a circular tube.

15. The method of claim 14, wherein the stiffeners are attached to an outer surface of the circular tube.

16. The method of claim 14, further comprising cutting the circular tube along a longitudinal direction of the tube, and opening the cut tube to form a selected shape of the ground vehicle panel.

17. The method of claim 16, wherein at least a portion of the ground vehicle panel comprises a substantially flat exterior surface.

18. The method of claim 13, wherein the panel and stiffeners have lengths approximating a length of the ground vehicle.

19. The method of claim 13, wherein the panel comprises an exterior side panel of the ground vehicle.

20. The method of claim 13, wherein the panel comprises an exterior top panel of the ground vehicle.

21. The method of claim 13, wherein the panel has a thickness of from about 0.03 to about 0.3 inch.

22. The method of claim 13, wherein the stiffeners extend from the panel a height of from about 0.5 to about 2 inches.

23. The method of claim 13, wherein the stiffeners have a thickness of from about 0.03 to about 0.3 inch.

24. The method of claim 13, wherein the stiffeners are substantially T-shaped with a base portion of the stiffener attached to the panel and a cross member attached to the base portion.

25. The method of claim 24, wherein the base portion has a thickness of from about 0.03 to about 0.3 inch and a height of from about 0.5 to about 2 inches, and the cross member has a thickness of from about 0.05 to about 0.3 inch and a width of from about 0.5 to about 2 inches.

26. The method of claim 13, wherein the stiffeners are spaced from each other on the panel a distance of from about 1 to about 10 inches.

27. The method of claim 13, wherein the panel and stiffeners comprise an aluminum alloy.

28. The method of claim 27, wherein the aluminum alloy comprises scandium.

29. An integrally stiffened ground vehicle panel assembly comprising:
a first panel including an extruded exterior metal panel with co-extruded interior metal stiffeners; and
a second panel connected to an edge of the first panel.

30. The integrally stiffened ground vehicle panel assembly of claim 29, wherein the first and second panels are connected by a weld.

31. The integrally stiffened ground vehicle panel assembly of claim 29, wherein the first and second panels are connected by mechanical fasteners.

32. The integrally stiffened ground vehicle panel assembly of claim 29, wherein either the first or second panel comprises an exterior side panel of the ground vehicle.

33. The integrally stiffened ground vehicle panel assembly of claim 29, wherein either the first or second panel comprises an exterior top panel of the ground vehicle.

34. The integrally stiffened ground vehicle panel assembly of claim 29, wherein the first panel comprises an exterior side panel of the ground vehicle.

35. The integrally stiffened ground vehicle panel assembly of claim 34, wherein the exterior side panel extends from the side of the ground vehicle over at least a portion of the top of the ground vehicle.

36. The integrally stiffened ground vehicle panel assembly of claim 35, wherein the second panel forms a portion of the top of the ground vehicle.

37. The integrally stiffened ground vehicle panel assembly of claim 29, wherein the second panel comprises an extruded exterior metal panel and co-extruded interior metal stiffeners attached to the metal panel.
